(19) United States
(12) Patent Application Publication
(10) Pub. No.: US 2024/0161117 A1
(43) Pub. Date: May 16, 2024

(54) Trigger-Based Electronic Fund Transfers

(71) Applicant: Bank of America Corporation, Charlotte, NC (US)

(72) Inventors: Lalit Dhawan, Franklin Park, NJ (US); Manu Kurian, Dallas, TX (US)

(21) Appl. No.: 17/985,420

(22) Filed: Nov. 11, 2022

(51) Int. Cl. G06Q 20/40; G06Q 20/10; G06Q 40/02

(52) U.S. Cl. CPC G06Q 20/405; G06Q 20/108; G06Q 40/025

(57) ABSTRACT

Systems, devices, and methods for machine learning based processing of large transactions (e.g., business-to-business (B2B) fund transfers) is described. A transaction management platform may incrementally process a payment transaction based on one or more trigger points. The one or more trigger points may be based on analysis of a transaction history associated with a source account of the transaction.

### FIELD

Aspects described herein generally relate to the field of artificial intelligence (AI) and machine learning (ML), and more specifically to using AI/ML algorithms for processing and financing commercial transactions.

### BACKGROUND

Transactions between two entities (e.g., business or consumer entities) may involve exchange of goods and/or currency as per a defined agreement of terms. For example, a seller may agree to provide services or goods in exchange of a buyer providing an agreed upon value of funds. The buyer may transfer the funds via one or more transaction channels (e.g., cash, check, wire/electronic transfers, credit card, etc.) to the seller. Transactions may involve two business entities (e.g., business-to-business (B2B) transactions) or may be between a business and a retail consumer (e.g., business-to-consumer (B2C) transactions). B2B transactions generally require significant amounts of time for payment processing. For example, while B2C payments can generally get processed/completed within a day or two, B2B payments may sometimes requires up to 60-90 days for completion. Once major reason for delays associated with B2B payments is that financial institutions (e.g., banking institutions that may finance the transactions) may require significant amounts of time to conduct all necessary checks required to process and approve the significant loan values and further approve the transfer of funds that may be associated with such transactions.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address time delay issues associated with fund transfers associated with large (e.g., B2B) transactions. In accordance with various considerations described herein, a computing platform may receive instructions for executing a fund transfer, and step-wise/conditionally transfer portions fo funds (between source account(s) and a destination account(s)) in response to various processing steps being completed (e.g., as indicated by the various subsystems in the computing network). Other embodiments described herein enable the use of machine learning algorithms to provide flexible financing to a buyer based on predicted demand associated with a product/service, as provided by the buyer.

In accordance with one or more arrangements, a transaction management platform may comprise at least one processor; and memory storing computer-readable instructions that, when executed by the at least one processor, cause the transaction management platform to perform one or more operations. In accordance with one or more arrangements, the transaction management platform may receive, from a user computing device, a receive, from a user computing device associated with at least one first banking account, a transaction request for processing a payment transaction to at least one second banking account. The transaction request may comprise: a transaction value; and metadata associated with the transaction. The metadata may comprise at least one of: identification associated with the first banking account and the second banking account, transaction history associated with the first banking account, and/or invoice data associated with the transaction. The transaction management platform may send, to an identification server, the identification associated with the first banking account and the second banking account. Based on receiving an indication of validation of the identification, the transaction management platform may send an indication to transfer a first portion of the transaction value from the first banking account to the second banking account. Based on determining that the transaction history is non-anomalous, the transaction management platform may send an indication to transfer a second portion of the transaction value from the first banking account to the second banking account. Based on receiving an approval notification associated with the invoice data, the transaction management platform may send an indication to transfer a third portion of the transaction value from the first banking account to the second banking account.

In some arrangements, the transaction management platform may receive, from the user computing device, values of product sales over a plurality of historical time periods. The transaction management platform may predict, using a seasonal autoregressive integrated moving average (SARIMA) model of the product sales over the plurality of historical time periods, future product sales in one or more future time periods. Based on the future product sales, the transaction management platform may determine a loan value. The transaction management platform may send, to the user computing device, an indication of the loan value.

In some arrangements, the transaction management platform may receive a text description associated with the product. Based on natural language processing (NLP) of the text description, the transaction management platform may extract one or more keywords associated with the text description. The transaction management platform may determine, based on the one or more keywords, an item group associated with the product. The transaction management platform may determine, based on the item group, a dataset associated with the item group. The dataset indicates growth rates associated with the item group over the plurality of historical time periods. The transaction management platform may determine the loan value based on predicting, using a SARIMA model of the growth rates over the plurality of historical time periods, future growth rates in the one or more future time periods.

In some arrangements, the transaction management platform may determine that the transaction history is non-anomalous based on performing a clustering analysis on transactions in a transaction history, of the first banking account, to organize the transactions into one or more groups.

In some arrangements, the transaction management platform may determine that the transaction history is non-anomalous based on determining that each transaction in the transaction history within a threshold time period immediately preceding the transaction request is non-anomalous.

In some arrangements, the transaction management platform may determine that a transaction in the transaction history is non-anomalous based on determining that respective distances between a set of parameters associated with the transaction and core points of the one or more groups is less than or equal to a threshold.

In some arrangements, the set of parameters associated with the transaction may comprise one or more of: an incoming value of the transaction in the transaction history, an outgoing value of the transaction in the transaction history, a source account associated with the transaction in the transaction history, a destination account associated with the transaction in the transaction history, or a transfer channel associated with the transaction in the transaction history.

In some arrangements, the clustering analysis may comprise one or more of hierarchical clustering, centroid based clustering, density based clustering, or distribution based clustering.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for transaction management, in accordance with one or more arrangements;

FIG. 1B shows an example transaction management platform, in accordance with one or more example arrangements;

FIG. 2 shows an example method for performing incremental transaction processing between a source account and a destination account, in accordance with one or more example arrangements;

FIG. 3 shows an example method for providing flexible financing for a buyer associated with a transaction, in accordance with one or more example arrangements; and

FIG. 4 shows a simplified example of an artificial neural network 400 on which a machine learning algorithm may be executed, in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

B2B transactions, involving fund transfers between two or more enterprises, may involve numerous steps for ensuring security and regulatory compliance. For example, a financial institution may be a lending agency funding the transaction and may wish to ensure that the product/property being offered is legitimately owned by the seller, the service is legal within the jurisdiction within which the financial institution, the buyer and the seller operates, the product/service has been invoiced correctly by the buyer, etc. Additional steps may involve required approval by regulatory agencies that oversee the transaction in accordance with national regulations as enforced by the government. As another example, the financial institution may be required to determine whether the funds being used by a buyer, for the transaction, are legitimate and/or are allowed to be used by the buyer (e.g., are not funds that belong to another entity). Once the checks are completed, the financial institution may then process the fund transfer to the seller accounts. These checks may often involve manual oversight by numerous individuals and agencies, and may prolong the time periods required for closing a B2B transaction and processing the fund transfer. As such, it is not uncommon for B2B transactions to take 2-3 months for completion.

Various examples herein describe incremental transfers between accounts based on triggers associated with a transaction between a buyer and a seller. The triggers may correspond to various compliance, regulatory, and identification checks. A transaction management platform may receive update information, from one or more other subsystems in the banking/financial network, associated with performance of one or more steps of the transaction. Based the update information, the transaction management platform may perform fund transfers between a buyer account and a seller account. The incremental nature of fund transfers may ensure availability of at least some funds in a destination account even if some steps of the transaction are being processed by one or more entities associated with the transaction. This may ensure reduced time overhead for B2B transactions.

In one or more arrangements, a machine learning module, associated with the transaction management platform, may flexibly provide financing to a buyer based on the product/service being offered by the buyer. For example, the machine learning platform may predict future market demand associated with the product and offer financing based on the projected market demand.

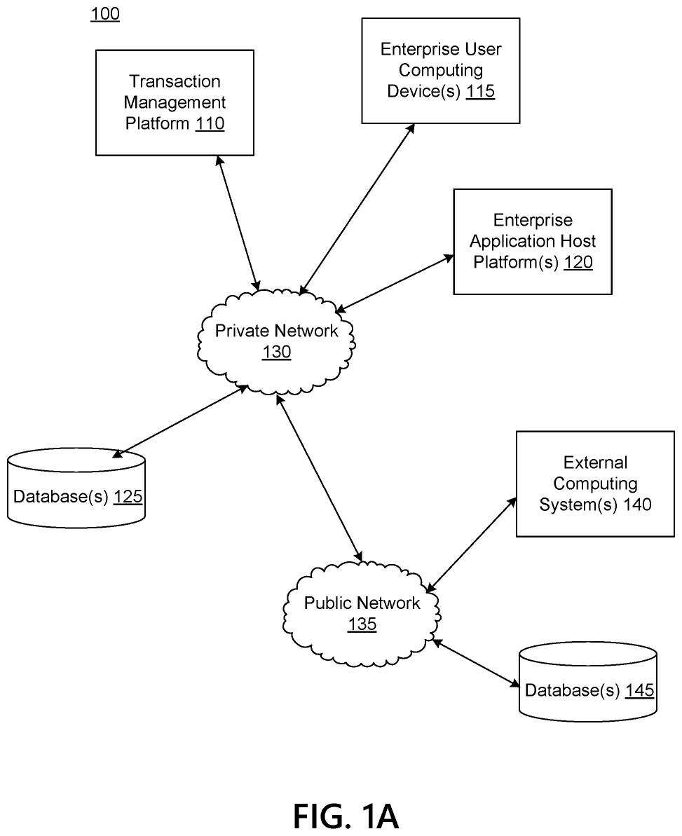

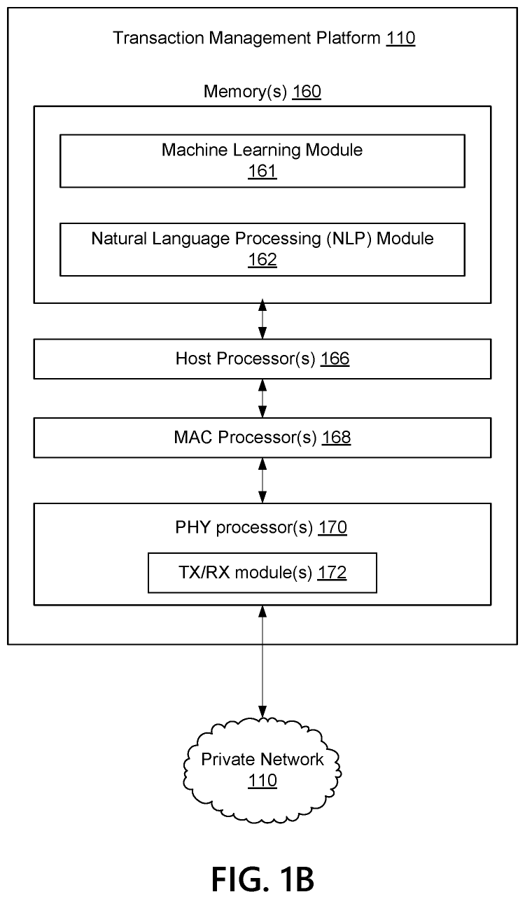

FIG. 1A shows an illustrative computing environment 100 for transaction management, in accordance with one or more arrangements. The computing environment 100 may comprise one or more devices (e.g., computer systems, communication devices, and the like). The one or more devices may be connected via one or more networks (e.g., a private network 130 and/or a public network 135). For example, the private network 130 may be associated with an enterprise organization which may develop and support service, applications, and/or systems for its end-users. The computing environment 100 may comprise, for example, a transaction management platform 110, one or more enterprise user computing device(s) 115, one or more enterprise application host platform(s) 120, and/or a database 125 connected via the private network 130. Additionally, the computing environment 100 may comprise one or more external computing systems 140 and databases 145 connected, via the public network 135, to the private network 130. Devices in the private network 130 and/or authorized devices in the public network 135 may access services, applications, and/or systems provided by the enterprise application host platform 120 and supported/serviced/maintained by the transaction management platform 110.

The devices in the computing environment 100 may transmit/exchange/share information via hardware and/or software interfaces using one or more communication protocols over the private network 130 and/or the public network 135. The communication protocols may be any wired communication protocol(s), wireless communication protocol(s), one or more protocols corresponding to one or more layers in the Open Systems Interconnection (OSI) model (e.g., a local area network (LAN) protocol, an Institution of Electrical and Electronics Engineers (IEEE) 802.11 WIFI protocol, a 3r d Generation Partnership Project (3GPP) cellular protocol, a hypertext transfer protocol (HTTP), and the like).

The transaction management platform 110 may comprise one or more computing devices and/or other computer components (e.g., processors, memories, communication interfaces) configured to perform one or more functions as described herein. Further details associated with the architecture of the transaction management platform 110 are described with reference to FIG. 1B.

The enterprise application host platform 120 may comprise one or more computing devices and/or other computer components (e.g., processors, memories, communication interfaces). In addition, the enterprise application host platform 120 may be configured to host, execute, and/or otherwise provide one or more services/applications for the end users. The end users may be employees associated with the enterprise organization, or may be consumers of a product/service provided by the enterprise organization. For example, if the computing environment 100 is associated with a financial institution, the enterprise application host platform 120 may be configured to host, execute, and/or otherwise provide one or more transaction processing programs (e.g., online banking applications, fund transfer applications, electronic trading applications), applications for generation of regulatory reports, loan processing/dispersing, and/or other programs associated with the financial institution. The above are merely exemplary use-cases for the computing environment 100, and one of skill in the art may easily envision other scenarios where the computing environment 100 may be utilized to provide and support end-user applications.

The enterprise user computing device(s) 115 may be personal computing devices (e.g., desktop computers, laptop computers) or mobile computing devices (e.g., smartphones, tablets). In addition, the enterprise user computing device(s) 115 may be linked to and/or operated by specific enterprise users (who may, for example, be employees or other affiliates of the enterprise organization).

The database 125 may store account data associated with accounts corresponding to the financial institution. For example, the account data may comprise transaction data, account balances, profile information, account authentication information associated with user accounts maintained by the financial institution. The database 125 may further store market data, gathered over time (e.g., estimated nationwide sales, historical sales, market size, growth rate), associated with a plurality of item groups across various industry sectors. In an example, the market data may be determined based on/comprise data provided by federal agencies.

The external computing systems 140 and databases 145 may be associated with external computing networks that the transaction management platform 110 may communicate with to facilitate triggered processing of a requested fund transfer. For example, the external computing systems 140/databases 145 may correspond to computing networks or devices of other banking/financial institutions (e.g., a banking institution associated with a seller), a computing network to facilitate interbank fund transfers, databases associated with identity verification services, databases associated with property deed verification services, computing networks, databases, or devices associated with regulatory authorities, etc. The transaction management platform 110 may communicate with the external computing systems 140/databases 145 to perform various steps associated with verification and compliance for processing fund transfers between a buyer account and a seller account.

In one or more arrangements, the transaction management platform 110, the knowledge base 125, the enterprise user computing device(s) 115, the enterprise application host platform(s) 120, the computing device(s) 140, and/or the other devices/systems in the computing environment 100 may be any type of computing device capable of receiving input via a user interface, and communicating the received input to one or more other computing devices in the computing environment 100. For example, the transaction management platform 110, the knowledge base 125, the enterprise user computing device(s) 115, the enterprise application host platform(s) 120, the computing device(s) 140, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the transaction management platform 110, the knowledge base 125, the enterprise user computing device(s) 115, the enterprise application host platform(s) 120, the computing device(s) 140, and/or the other devices/systems in the computing environment 100 may, in some instances, be and/or comprise special-purpose computing devices configured to perform specific functions.

FIG. 1B shows an example transaction management platform 110, in accordance with one or more examples described herein. The transaction management platform 110 may comprise one or more of host processor(s) 166, medium access control (MAC) processor(s) 168, physical layer (PHY) processor(s) 170, transmit/receive (TX/RX) module(s) 172, memory 160, and/or the like. One or more data buses may interconnect host processor(s) 166, MAC processor(s) 168, PHY processor(s) 170, and/or Tx/Rx module(s) 172, and/or memory 160. The transaction management platform 110 may be implemented using one or more integrated circuits (ICs), software, or a combination thereof, configured to operate as discussed below. The host processor(s) 166, the MAC processor(s) 168, and the PHY processor(s) 170 may be implemented, at least partially, on a single IC or multiple ICs. Memory 160 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 168 and/or the PHY processor(s) 170 of the transaction management platform 110 may be configured to generate data units, and process received data units, that conform to any suitable wired and/or wireless communication protocol. For example, the MAC processor(s) 168 may be configured to implement MAC layer functions, and the PHY processor(s) 170 may be configured to implement PHY layer functions corresponding to the communication protocol. The MAC processor(s) 168 may, for example, generate MAC data units (e.g., MAC protocol data units (MPDUs)), and forward the MAC data units to the PHY processor(s) 170. The PHY processor(s) 170 may, for example, generate PHY data units (e.g., PHY protocol data units (PPDUs)) based on the MAC data units. The generated PHY data units may be transmitted via the TX/RX module(s) 172 over the private network 130. Similarly, the PHY processor(s) 170 may receive PHY data units from the TX/RX module(s) 172, extract MAC data units encapsulated within the PHY data units, and forward the extracted MAC data units to the MAC processor(s). The MAC processor(s) 168 may then process the MAC data units as forwarded by the PHY processor(s) 170.

One or more processors (e.g., the host processor(s) 166, the MAC processor(s) 168, the PHY processor(s) 170, and/or the like) of the transaction management platform 110 may be configured to execute machine readable instructions stored in memory 160. The memory 160 may comprise one or more program modules/engines having instructions that when executed by the one or more processors cause the transaction management platform 110 to perform one or more functions described herein. The one or more program modules/engines and/or databases may be stored by and/or maintained in different memory units of the transaction management platform 110 and/or by different computing devices that may form and/or otherwise make up the transaction management platform 110. For example, the memory 160 may have, store, and/or comprise a machine learning module 161 and a natural language processing (NLP) module 162.

The transaction management platform 110 may access communications between the various devices/systems within the computing environment 100. For example, the transaction management platform 110 may be configured to receive, process, and store data/communications corresponding to one or more of account transfers, wire transfers, automatic clearing house (ACH) transfers, transfers in accordance with any other electronic fund transfer (EFT) systems/protocols; receive/approve transfer requests; and/or send transfer approval notifications to one or more other devices, systems, and/or networks within the computing environment 100. In addition, the transaction management platform 110, may process and/or approve flexible financing options for a buyer.

The machine learning module 161 may have instructions/algorithms that may cause the transaction management platform 110 to implement machine learning processes in accordance with the examples described herein. The machine learning module 161 may receive data (e.g., from the communications with the computing platform 100) and, using one or more machine learning algorithms, may generate one or more machine learning datasets. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

In one example where the machine learning module 161 implements a clustering algorithm, the machine learning module 161 may comprise instructions/algorithms that may cause the transaction management platform 110 to perform clustering operations on metadata associated with an account transaction history (e.g., as stored in the database 125). For example, the clustering operations may comprise performing non-supervised machine learning operations on the transaction history (e.g., transfer values, periodicities, source/destination accounts, and/or the like) to categorize the metadata into a plurality of groups. The clusters can then be used to detect potential anomalous account activity, by the transaction management platform 110, prior to approving a fund transfer.

The NLP module 162 may be used to process an item description (e.g., as input by a buyer) for securing financing for a transaction (e.g., for purchase of property, raw material, goods, services, and/or the like). The item description may be, for example, a description of what the transaction proceeds (e.g., property, raw material, goods, services, and/or the like) are to be used for by the buyer (e.g., products/services as offered by the buyer). The NLP module 162 may extract various keywords from the description and classify the item into an item group. Based on the item group, a dataset may be selected for predictive analysis to be performed by the machine learning module 161. The predictive analysis may be for estimating growth/market potential for the product/service being offered by the buyer (which would be created using the transaction proceeds). Based on the estimated growth, the transaction management platform may provide flexible financing options for a buyer.

While FIG. 1A illustrates the transaction management platform 110, the enterprise user computing device(s) 115, the enterprise application host platform 120, and the knowledge base 125 as being separate elements connected in the private network 130, in one or more other arrangements, functions of one or more of the above may be integrated in a single device/network of devices. For example, elements in the transaction management platform 110 (e.g., host processor(s) 166, memory(s) 160, MAC processor(s) 168, PHY processor(s) 170, TX/RX module(s) 172, and/or one or more program/modules stored in memory(s) 160) may share hardware and software elements with and corresponding to, for example, the enterprise application host platform 120 and/or the enterprise user device(s) 115.

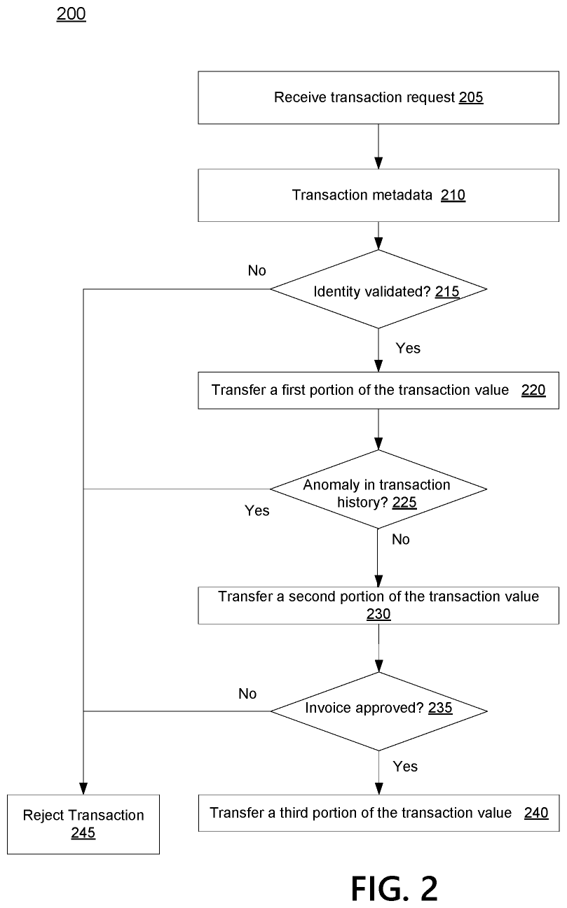

FIG. 2 shows an example method 200 for performing incremental transaction processing between a source account and a destination account. The example method 200 may be performed, for example, by the transaction management platform 110. A buyer as referred herein may correspond to a business purchasing goods, services, or any other tangible property in exchange of funds. A seller as referred herein may correspond to a business purchasing goods, services, or any other tangible property in exchange of funds

At step 205, the transaction management platform 110 may receive a transaction request. In an arrangement, the transaction request may be sent by the enterprise user computing device 115, the enterprise application host platform, or any other computing device connected to the private network 130 or the public network 135. The transaction request may be for a fund transfer for a B2B transaction (e.g., wire transfers, ACH transfers, transfers in accordance with any other electronic fund transfer (EFT) systems/protocols).

The transaction request may indicate a transaction value. The transaction request may further indicate at least one of: identity data associated with the buyer and the seller, one or more source accounts (e.g., associated with a buyer) of the fund transfer, one or more destination accounts (e.g., associated with a seller) of the fund transfer, invoice data (e.g., as provided by the seller), deed/title data (e.g., as provided by seller, for example, if the transaction is for an immovable asset), etc.

At step 215, the transaction management platform 215 may communicate with one or more external systems to verify the identity data. For example, the identity data may comprise electronic copies of identification documents (e.g., passports, drivers' licenses, etc.) of authorized individuals associated with the buyer and the seller. The transaction management platform 110 may send the identity data, for example, to an external vendor providing identity verification services. For example, the vendor may be associated with the external computing system 140).

At step 220, based on receiving an indication, from the one or more external systems, that the identity data is valid, the transaction management platform 110 may initiate a first fund transfer from the one or more source accounts to the one or more destination accounts. The first fund transfer may be equal, in value, to a first portion of the transaction value. The one or more external systems may validate the identity data based on a stored database of verified identities (e.g., in the database 145). Conversely, at step 245, based on receiving an indication, from the one or more external systems, that the identity data is not valid, the transaction management platform 110 may reject further processing of the transaction request.

At step 225, the transaction management platform 110 may review the transaction history associated with one or more source accounts. The transaction management platform 110 may query the database 125 to determine the transaction history associated with the one or more source accounts. Determining the transaction history may comprise determining incoming and outgoing values of funds/fund transfers, source accounts/destination accounts associated with the fund transfers, a transfer channel associated with the fund transfers (e.g., whether the fund transfer was via ACH transfer, wire transfer, cash, check, and/or the like), day of the month for the fund transfers, etc.

The transaction management platform 110 may use a clustering algorithm to categorize/group transactions in the transaction history into one or more groups/clusters. The clustering may be based on values of funds/fund transfers, source accounts/destination accounts associated with the fund transfers, the transfer channels associated with the fund transfers. The clustering algorithm may comprise one or more of hierarchical clustering, centroid based clustering, density based clustering, and/or distribution based clustering.

A transaction, within the transaction history, may be determined to be anomalous, for example, if a set of parameters associated with the transaction (e.g., incoming and/or outgoing values of a fund transfer, source account/destination account associated with the fund transfer, a transfer channel associated with the fund transfer) is determined to be outside of the determined clusters of transactions. For example, the set of parameters may be to be outside the determined cluster(s) if the distance(s) between the set of parameters and core point(s) associated with the cluster (s) is/are greater than a threshold value. Based on this determination, the transaction associated with the set of parameters may be determined to be anomalous.

A transaction, within the transaction history, may be determined to be non-anomalous, for example, if a set of parameters associated with the transaction (e.g., incoming and/or outgoing values of a fund transfer, source account/destination account associated with the fund transfer, a transfer channel associated with the fund transfer) is determined to be within the determined clusters of transactions. For example, the set of parameters may be to be outside the determined cluster(s) if the distance(s) between the set of parameters and core point(s) associated with the cluster (s) is/are less than (or equal to) the threshold value. Based on this determination, the transaction associated with the set of parameters may be determined to be non-anomalous.

If an anomalous transaction is within a threshold time period (or within a threshold number of transactions) immediately preceding the transaction request, at step 225, the transaction monitoring platform 110 may flag an anomaly and reject further processing of the transaction (e.g., step 245). The transaction monitoring platform 110 may not initiate any additional fund transfers for the received transaction request.

If an anomalous transaction is outside the threshold time period (or outside a threshold number of transactions) immediately preceding the transaction request or if no anomalous transaction is detected within the transaction history, at step 225, the transaction monitoring platform 110 may not flag an anomaly and may further process the transaction (e.g., step 230). For example, the transaction management platform 110 may initiate a second fund transfer from the one or more source accounts to the one or more destination accounts. The second fund transfer may be equal, in value, to a second portion of the transaction value. The second portion may be equal to or may be different from the first portion.

At step 235, the transaction management platform 110 may determine whether an invoice (e.g., as provided by the seller) has been approved (e.g., by the buyer) for processing. For example, the transaction management platform may wait for an indication (e.g., from a computing device associated with the buyer) of whether or not the invoice has been approved for processing and payment. At step 240, and based on receiving an indication of approval of the invoice, the transaction management platform 110 may initiate a third fund transfer from the one or more source accounts to the one or more destination accounts. The third fund transfer may be equal, in value, to a third portion of the transaction value. The third portion may be equal to or may be different from the first portion and/or the second portion. Based on receiving an indication of non-approval of the invoice, the transaction management platform 110 may reject further processing of the transaction (e.g., step 245). The transaction monitoring platform 110 may not initiate any additional fund transfers for the received transaction request.

The various checks performed at steps 215, 225, and 235 are merely exemplary. The steps may be performed in any other order different from that of the method 200. One or more of the steps may be removed from the method 200. One or more additional processing steps may be added to the method 200. For example, the transaction management platform 110 may communicate with one or more databases/computing platforms/networks to determine a source of the funds being used for the transaction request. If the source is flagged (e.g., by regulatory agencies), the transaction may be rejected.

Initiating a fund transfer (e.g., as described with respect to steps 220, 230, and 240) may comprise sending one or more indications to modify the database 125 to transfer funds from the one or more source accounts to the one or more destination accounts. Initiating a fund transfer may comprise sending one or more indications to external devices/servers (e.g., corresponding to external networks) indicating transfer of funds from the one or more source accounts to the one or more destination accounts. The external servers may comprise, for example, servers associated with inter-bank transfers (e.g., electronic fund transfers (EFTs), ACH transfers, wire transfers, etc.).

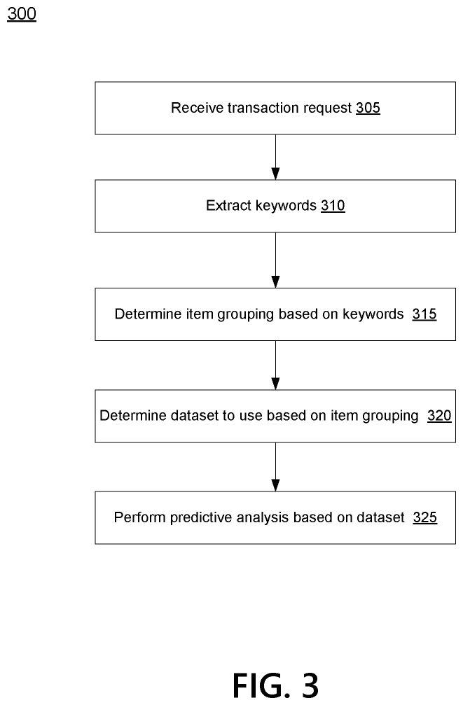

FIG. 3 shows an example method 300 for providing flexible financing for a buyer associated with a transaction. The transaction may be a fund transfer (e.g., wire transfers, ACH transfers, transfers in accordance with any EFT systems/protocols). The fund transfer may be for purchasing goods, services, or any other tangible property, in exchange of funds, from a seller.

At step 305, the transaction management platform may receive a transaction request. The transaction request may be for a fund transfer for a B2B transaction. In an arrangement, the transaction request may be sent by the enterprise user computing device 115, the enterprise application host platform, or any other computing device connected to the private network 130 or the public network 135.

The transaction request may indicate a transaction value. The transaction request may further indicate at least one of: identity data associated with the buyer and the seller, one or more source accounts (e.g., associated with a buyer) of the fund transfer, one or more destination accounts (e.g., associated with a seller) of the fund transfer, invoice data (e.g., as provided by the seller), deed/title data (e.g., as provided by seller, for example, if the transaction is for an immovable asset), etc. Additionally, the transaction request may indicate a description/memo associated with the transaction. For example, a buyer may indicate what the funds are for. In an arrangement, the funds may be for purchase of equipment and raw material associated with manufacture of a specific product by the buyer. In this example, the buyer may indicate in the description the nature/description of the raw material, equipment, and the products to be manufactured using the raw material and equipment.

At step 310, the transaction management platform 110 may extract keywords from the description. For example, the NLP module 162 may use a keyword extraction algorithm for identifying one or more keywords. The keyword extraction algorithm may remove words that may occur with high frequency and may not convey any useful information (e.g., a, an, the, in, on, etc.) and further remove any forms of punctuation and/or special characters that may be used. The keyword extraction algorithm may further extract the most-commonly used keywords and/or n-grams within the service request description and the identified communications. The keyword extraction algorithm may enable determination of words and/or phrases that may correspond to description of raw material, products being manufactured, potential locations of sales of the products, etc.

Based on the keywords and a quantity of the keywords present in the memo, the transaction management platform 110 may determine an item group (e.g., associated with the product). The item group may be an indicator of an industry sector that the product is aimed for. For example, if the detected keywords include the words clothing, menswear, etc., the item group may be determined to be “textiles and associated industries.” For example, if the detected keywords include the words laptop computer, speakers, computer peripherals, etc., the item group may be determined to be “home electronics.” The database 125 may store a look-up table mapping a plurality of keywords with corresponding item groups. The transaction management platform 110 may determine the item group by querying the look-up table using the extracted keywords.

As explained previously, the database 125 may store market data (e.g., nationwide sales, market size, growth rate) associated with a plurality of item groups across various industry sectors (e.g., as measured over a plurality of historical time periods). The market data may comprise corresponding datasets associated with each of the plurality of item groups. At step 320, and based on the determined item group, the transaction management platform 110 may determine a dataset associated with the item group.

At step 325, and based on the determined dataset, the transaction management platform 110 may perform predictive analysis to determine various metrics associated with future growth corresponding to the item group. The various metrics may comprise, for example, an industry-wide growth rate, sales, market value, etc. Performing predictive analysis may comprise applying, for example, time-series algorithms.

An example time series algorithm used by the transaction management platform 110 may comprise using an autoregressive integrated moving average (ARIMA) model of a metric (e.g., growth rate, sales, market value). An ARIMA model of a time series y (e.g., sales over multiple time periods) may be represented by a model equation:

Yₜ=α+(β₁Yₜ₋₁+β₂Yₜ₋₂+ . . . βₚYₜ₋ₚ)−(θ₁eₜ₋₁−θ₂eₜ₋₂− . . . θ_{q}e_{t-q}) Equation (1)

where (β₁Yₜ₋₁+β₂Yₜ₋₂+ . . . βₚYₜ₋ₚ) is the autoregression (AR) component, and (θ₁e^{t-1}−θ₂eₜ₋₂− . . . θ₁e_{t-q}) is the moving average (MA) component. Yₜ, Yₜ₋₁, Yₜ₋₂, . . . Yₜ₋ₚ may correspond to model fit values of the time series or the model fit values with one or more differencing transformations applied. eₜ₋₁, eₜ₋₂, . . . e_{t-q} may correspond to errors between values of the time series y and the model fit values. Building the ARIMA model may comprise determining values of α, βᵢ, and θᵢ based on historical values of time series y (e.g., training values). The model equation may then be used to predict future values of the time series y.

A time series that exhibits a certain degree of periodicity with time may be said to be seasonal and a seasonal ARIMA (SARIMA) model may be used to model the time series. A SARIMA model equation may have additional terms (e.g., MA components, AR components) that apply seasonality to the ARIMA model. The additional terms may use values of Y corresponding to prior seasons in a model equation. Outgoing data volumes from a user device, for example, may exhibit a weekly periodic behavior. The SARIMA model may account for this periodicity.

Performing predictive analysis on the dataset may comprise using the ARIMA/SARIMA model (e.g., obtained using past data) to predict future metrics. The transaction management platform 110 may provide financing (e.g., an offered loan amount) based on one or more future metrics as predicted using the ARIMA/SARIMA model. In an example, the transaction management platform 110 may send an indication of an offered loan amount that is proportional to a future determined metric (e.g., market sales).

Provisioning flexible loans, as described with respect to FIG. 3, may be used in conjunction with the method as described with respect to FIG. 2. For example, if the buyer accepts the loan as offered, the loan amount may be transferred in increments, based on satisfaction of one or more conditions, as described with respect to FIG. 2.

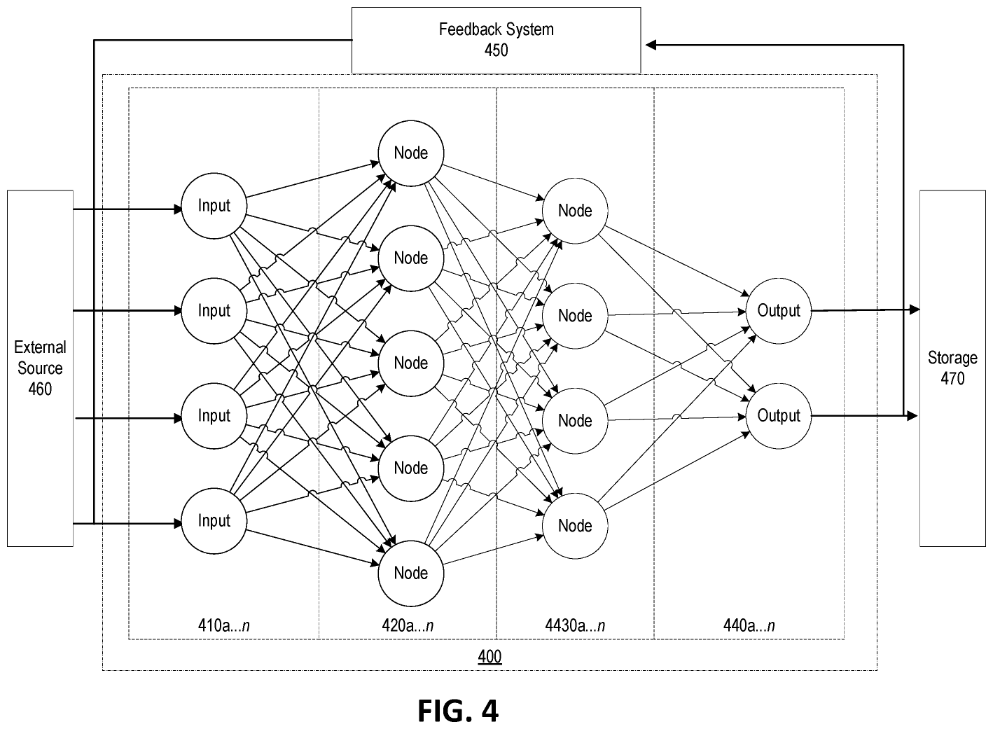

Another technique that may be used to offer flexible financing may employ neural network-based algorithms. FIG. 4 shows a simplified example of an artificial neural network 400 on which a machine learning algorithm may be executed, in accordance with one or more example arrangements. The machine learning algorithm may be in accordance with the instructions stored in the machine learning module 161 for performing one or more functions of the machine learning platform 110, as described herein. The machine learning algorithm is merely an example of nonlinear processing using an artificial neural network; other forms of nonlinear processing may be used to implement a machine learning algorithm in accordance with features described herein.

In one example, a framework for a machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks. Such structures, while significantly more complex than conventional computer systems, are beneficial in implementing machine learning. For example, an artificial neural network may be comprised of a large set of nodes which, like neurons, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 4000 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”).

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (4) regression functions where the function being learned is continuous; and (3) probability estimations where the output of the function is a probability.

In practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

By way of example, in FIG. 4, each of input nodes 410a-n is connected to a first set of processing nodes 420a-n. Each of the first set of processing nodes 420a-n is connected to each of a second set of processing nodes 430a-n. Each of the second set of processing nodes 430a-n is connected to each of output nodes 440a-n. Though only two sets of processing nodes are shown, any number of processing nodes may be implemented. Similarly, though only four input nodes, five processing nodes, and two output nodes per set are shown in FIG. 4, any number of nodes may be implemented per set. Data flows in FIG. 4 are depicted from left to right: data may be input into an input node, may flow through one or more processing nodes, and may be output by an output node. Input into the input nodes 410a-n may originate from an external source 460.

In one illustrative method using feedback system 450, the system may use machine learning to determine an output. The system may use one of a myriad of machine learning models including xg-boosted decision trees, auto-encoders, perceptron, decision trees, support vector machines, regression, and/or a neural network. The neural network may be any of a myriad of type of neural networks including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality. Output may be sent to a feedback system 450 and/or to storage 470.

In an arrangement the neural network 400 may be used for providing flexible financing. The input from the input nodes may comprise sales of a product/service offered by a buyer (e.g., over a predetermined number of historical time periods), buyer profits (e.g., over a predetermined number of historical time periods), an item group (e.g., as determined at step 315), etc. The various inputs required by the neural network 400 may be provided in a transaction request. In an arrangement, the transaction request may be sent by the enterprise user computing device 115, the enterprise application host platform, or any other computing device connected to the private network 130 or the public network 135. The output from the neural network may indicate a loan amount offered by the transaction management platform 110. The transaction management platform 110 may send an indication of the offered loan amount to the enterprise user computing device 115, the enterprise application host platform, or any other computing device.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L4), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially.

In one example, FIG. 4 depicts nodes that may perform various types of processing, such as discrete computations, computer programs, and/or mathematical functions implemented by a computing device. For example, the input nodes 410a-n may comprise logical inputs of different data sources, such as one or more data servers. The processing nodes 440a-n may comprise parallel processes executing on multiple servers in a data center. And, the output nodes 440a-n may be the logical outputs that ultimately are stored in results data stores, such as the same or different data servers as for the input nodes 410a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 400 may learn and/or be dynamically reconfigured. Though nodes are depicted as having connections only to successive nodes in FIG. 1, connections may be formed between any nodes. For example, one processing node may be configured to send output to a previous processing node.

Input received in the input nodes 410a-n may be processed through processing nodes, such as the first set of processing nodes 440a-n and the second set of processing nodes 430a-n. The processing may result in output in output nodes 440a-n. As depicted by the connections from the first set of processing nodes 440a-n and the second set of processing nodes 430a-n, processing may comprise multiple steps or sequences. For example, the first set of processing nodes 440a-n may be a rough data filter, whereas the second set of processing nodes 430a-n may be a more detailed data filter.

The artificial neural network 400 may be configured to effectuate decision-making. As a simplified example for the purposes of explanation, the artificial neural network 400 may be configured to detect faces in photographs. The input nodes 410a-n may be provided with a digital copy of a photograph. The first set of processing nodes 440a-n may be each configured to perform specific steps to remove non-facial content, such as large contiguous sections of the color red. The second set of processing nodes 430a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 400 may then predict the location on the face. The prediction may be correct or incorrect.

The feedback system 450 may be configured to determine whether or not the artificial neural network 400 made a correct decision. Feedback may comprise an indication of a correct answer and/or an indication of an incorrect answer and/or a degree of correctness (e.g., a percentage). For example, in the facial recognition example provided above, the feedback system 450 may be configured to determine if the face was correctly identified and, if so, what percentage of the face was correctly identified. The feedback system 450 may already know a correct answer, such that the feedback system may train the artificial neural network 400 by indicating whether it made a correct decision. The feedback system 450 may comprise human input, such as an administrator telling the artificial neural network 400 whether it made a correct decision. The feedback system may provide feedback (e.g., an indication of whether the previous output was correct or incorrect) to the artificial neural network 400 via input nodes 410a-n or may transmit such information to one or more nodes. The feedback system 450 may additionally or alternatively be coupled to the storage 470 such that output is stored. The feedback system may not have correct answers at all, but instead base feedback on further processing: for example, the feedback system may comprise a system programmed to identify faces, such that the feedback allows the artificial neural network 400 to compare its results to that of a manually programmed system.

The artificial neural network 400 may be dynamically modified to learn and provide better input. Based on, for example, previous input and output and feedback from the feedback system 450, the artificial neural network 400 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 400, such that the artificial neural network 400 may vary its nodes and connections to test hypotheses.

The artificial neural network 400 need not have a set number of processing nodes or number of sets of processing nodes, but may increase or decrease its complexity. For example, the artificial neural network 400 may determine that one or more processing nodes are unnecessary or should be repurposed, and either discard or reconfigure the processing nodes on that basis. As another example, the artificial neural network 400 may determine that further processing of all or part of the input is required and add additional processing nodes and/or sets of processing nodes on that basis.

The feedback provided by the feedback system 450 may be mere reinforcement (e.g., providing an indication that output is correct or incorrect, awarding the machine learning algorithm a number of points, or the like) or may be specific (e.g., providing the correct output). For example, the machine learning algorithm 400 may be asked to detect faces in photographs. Based on an output, the feedback system 450 may indicate a score (e.g., 75% accuracy, an indication that the guess was accurate, or the like) or a specific response (e.g., specifically identifying where the face was located).

In an exemplary neural network, an output from an output node may be expressed as a function of an input at the plurality of input nodes. For example, if the outputs from the first set of processing nodes 440a-n are represented as bₐ, b_{b} . . . bₙ and inputs from the input nodes 410a-n is represented as aₐ, a_{b} . . . aₙ, a value of an output node bₙ may be represented as:

bₙ=A(aₐwₐ+aₐw_{b}+ . . . aₙwₙ−x) Equation (1)

where A is the activation function, wₐ, w_{b} . . . wₙ are the weights applied to at the input nodes 410a-n, and x is a bias value applied to the function. Each output bₐ, b_{b} . . . bₙ from the first set of processing nodes may be similarly processed at the second set of processing nodes, each of which may be associated with its own set of biases and weights. Processing, in this manner at each of layers of intermediary nodes, outputs may be generated at the output nodes 440a-n. Training a neural network, as described above, comprises setting optimal values of weights and biases to achieve a required level of accuracy for a given function of the neural network.

Various examples herein describe the use of machine learning algorithms to incrementally process a B2B payment transaction. This may advantageously improve a processing time associated with the transaction. Additional examples herein enable the use of machine learning algorithms to provide flexible financing to the buyer. The flexible financing algorithms may be integrated within the B2B payment systems, enhancing interoperability between different systems associated with a financial organization.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising
a processor; and
memory storing computer-readable instructions that, when executed by the processor, cause the computing platform to:
receive, from a user computing device associated with at least one first banking account, a transaction request for processing a payment transaction to at least one second banking account, wherein the transaction request comprises:
a transaction value; and
metadata associated with the transaction, wherein the metadata comprises at least one of: identification associated with the first banking account and the second banking account, transaction history associated with the first banking account, and invoice data associated with the transaction;
send, to an identification server, the identification associated with the first banking account and the second banking account;
based on receiving an indication of validation of the identification, send an indication to transfer a first portion of the transaction value from the first banking account to the second banking account;
based on determining that the transaction history is non-anomalous, send an indication to transfer a second portion of the transaction value from the first banking account to the second banking account; and
based on receiving an approval notification associated with the invoice data, send an indication to transfer a third portion of the transaction value from the first banking account to the second banking account.

2. The computing platform of claim 1, wherein the computer-readable instructions that, when executed by the processor, cause the computing platform to:
receive, from the user computing device, values of product sales over a plurality of historical time periods;
predict, using a seasonal autoregressive integrated moving average (SARIMA) model of the product sales over the plurality of historical time periods, future product sales in one or more future time periods; and
based on the future product sales, determine a loan value; and
send, to the user computing device, an indication of the loan value.

3. The computing platform of claim 2, wherein the computer-readable instructions, when executed by the processor, cause the computing platform to:
receive a text description associated with the product;
based on natural language processing (NLP) of the text description, extract one or more keywords associated with the text description;
determine, based on the one or more keywords, an item group associated with the product;
determine, based on the item group, a dataset associated with the item group, wherein the dataset indicates growth rates associated with the item group over the plurality of historical time periods; and
determine the loan value by causing determining the loan value based on predicting using a SARIMA model of the growth rates over the plurality of historical time periods, future growth rates in the one or more future time periods.

4. The computing platform of claim 1, wherein the computer-readable instructions, when executed by the processor, cause the computing platform to determine that the transaction history is non-anomalous by causing performing a clustering analysis on transactions in a transaction history, of the first banking account, to organize the transactions into one or more groups.

5. The computing platform of claim 4, wherein the computer-readable instructions, when executed by the processor, cause the computing platform to determine that the transaction history is non-anomalous by causing determining that each transaction in the transaction history within a threshold time period immediately preceding the transaction request is non-anomalous.

6. The computing platform of claim 5, wherein the computer-readable instructions, when executed by the processor, cause the computing platform to determine that a transaction in the transaction history is non-anomalous based on determining that respective distances between a set of parameters associated with the transaction and core points of the one or more groups is less than or equal to a threshold.

7. The computing platform of claim 6, wherein the set of parameters associated with the transaction comprises one or more of:
an incoming value of the transaction in the transaction history,
an outgoing value of the transaction in the transaction history,
a source account associated with the transaction in the transaction history,
a destination account associated with the transaction in the transaction history, or
a transfer channel associated with the transaction in the transaction history.

8. The computing platform of claim 4, wherein the clustering analysis comprises one or more of hierarchical clustering, centroid based clustering, density based clustering, or distribution based clustering.

9. A method comprising:
receiving, from a user computing device associated with at least one first banking account, a transaction request for processing a payment transaction to at least one second banking account, wherein the transaction request comprises:
a transaction value; and
metadata associated with the transaction, wherein the metadata comprises at least one of: identification associated with the first banking account and the second banking account, transaction history associated with the first banking account, and invoice data associated with the transaction;
sending, to an identification server, the identification associated with the first banking account and the second banking account;
based on receiving an indication of validation of the identification, sending an indication to transfer a first portion of the transaction value from the first banking account to the second banking account;
based on determining that the transaction history is non-anomalous, sending an indication to transfer a second portion of the transaction value from the first banking account to the second banking account; and
based on receiving an approval notification associated with the invoice data, sending an indication to transfer a third portion of the transaction value from the first banking account to the second banking account.

10. The method of claim 9, further comprising:
receiving, from the user computing device, values of product sales over a plurality of historical time periods;
predicting, using a seasonal autoregressive integrated moving average (SARIMA) model of the product sales over the plurality of historical time periods, future product sales in one or more future time periods; and
based on the future product sales, determining a loan value; and
sending, to the user computing device, an indication of the loan value.

11. The method of claim 10, further comprising:
receiving a text description associated with the product;
based on natural language processing (NLP) of the text description, extracting one or more keywords associated with the text description;
determining, based on the one or more keywords, an item group associated with the product;
determining, based on the item group, a dataset associated with the item group, wherein the dataset indicates growth rates associated with the item group over the plurality of historical time periods;
wherein the determining the loan value comprises determining the loan value based on predicting, using a SARIMA model of the growth rates over the plurality of historical time periods, future growth rates in the one or more future time periods.

12. The method of claim 9, wherein the determining that the transaction history is non-anomalous comprises performing a clustering analysis on transactions in a transaction history, of the first banking account, to organize the transactions into one or more groups.

13. The method of claim 12, wherein the determining that the transaction history is non-anomalous comprises determining that each transaction in the transaction history within a threshold time period immediately preceding the transaction request is non-anomalous.

14. The method of claim 13, wherein the determining that a transaction in the transaction history is non-anomalous comprises determining that respective distances between a set of parameters associated with the transaction and core points of the one or more groups is less than or equal to a threshold.

15. The method of claim 14, wherein the set of parameters associated with the transaction comprises one or more of:
an incoming value of the transaction in the transaction history,
an outgoing value of the transaction in the transaction history,
a source account associated with the transaction in the transaction history,
a destination account associated with the transaction in the transaction history, or
a transfer channel associated with the transaction in the transaction history.

16. The computing platform of claim 12, wherein the clustering analysis comprises one or more of hierarchical clustering, centroid based clustering, density based clustering, or distribution based clustering.

17. One or more non-transitory computer-readable media storing instructions that, when executed by a computer processor, cause a computing platform to:
receive, from a user computing device associated with at least one first banking account, a transaction request for processing a payment transaction to at least one second banking account, wherein the transaction request comprises:
a transaction value; and
metadata associated with the transaction, wherein the metadata comprises at least one of: identification associated with the first banking account and the second banking account, transaction history associated with the first banking account, invoice data associated with the transaction;
send, to an identification server, the identification associated with the first banking account and the second banking account;
based on receiving an indication of validation of the identification, send an indication to transfer a first portion of the transaction value from the first banking account to the second banking account;
based on determining that the transaction history is non-anomalous, send an indication to transfer a second portion of the transaction value from the first banking account to the second banking account; and
based on receiving an approval notification associated with the invoice data, send an indication to transfer a third portion of the transaction value from the first banking account to the second banking account.

18. The non-transitory computer-readable media of claim 17, wherein the instructions that, when executed by the processor, cause the computing platform to:
receive, from the user computing device, values of product sales over a plurality of historical time periods;
predict, using a seasonal autoregressive integrated moving average (SARIMA) model of the product sales over the plurality of historical time periods, future product sales in one or more future time periods; and
based on the future product sales, determine a loan value; and
send, to the user computing device, an indication of the loan value.

19. The non-transitory computer-readable media of claim 18, wherein the instructions that, when executed by the processor, cause the computing platform to:
receive a text description associated with the product;
based on natural language processing (NLP) of the text description, extract one or more keywords associated with the text description;
determine, based on the one or more keywords, an item group associated with the product;
determine, based on the item group, a dataset associated with the item group, wherein the dataset indicates growth rates associated with the item group over the plurality of historical time periods; and
determine the loan value by causing determining the loan value based on predicting using a SARIMA model of the growth rates over the plurality of historical time periods, future growth rates in the one or more future time periods.

20. The non-transitory computer-readable media of claim 17, wherein the instructions that, when executed by the processor, cause the computing platform to determine that the transaction history is non-anomalous by causing performing a clustering analysis on transactions in a transaction history, of the first banking account, to organize the transactions into one or more groups.
